(19) United States
(12) Patent Application Publication
(10) Pub. No.: US 2025/0237860 A1
(43) Pub. Date: Jul. 24, 2025

(54) BRACKET FOR THE COMBINED USE OF OPTICAL DEVICES

(71) Applicants: Trent Leavitt, St. George, UT (US); Kaleb Leavitt, St. George, UT (US)

(72) Inventors: Trent Leavitt, St. George, UT (US); Kaleb Leavitt, St. George, UT (US)

(21) Appl. No.: 19/034,358

(22) Filed: Jan. 22, 2025

Related U.S. Application Data
(60) Provisional application No. 63/623,677, filed on Jan. 22, 2024.

(51) Int. Cl. G02B 23/18; F16M 11/10; G03B 17/56

(52) U.S. Cl. CPC G02B 23/18; F16M 11/10; G03B 17/561; F16M 2200/022

(57) ABSTRACT

An optical bracket for combining optic devices includes a lower arm couplable to a tripod, an upper arm couplable to the lower arm, and a top base hingedly coupled to the upper arm. In some examples, binoculars are situated above a spotting scope. The upper arm is vertically adjustable in relation to the lower arm, and the top base is angle adjustable in relation to the upper arm to ensure that the focal point of the binoculars matches that of the spotting scope. In use, a user will look through the binoculars to locate an item of interest. Once located, a user will tilt the binoculars forward via a hinge, allowing a user to then view through the spotting scope. Because the binoculars and the spotting scope have the same focal point, the item of interest is not lost during the transition from the binoculars to the spotting scope.

### CROSS-REFERENCE TO RELATED APPLICATIONS

This application claims the benefit of U.S. Provisional Application Ser. No. 63/623,677, filed on Jan. 22, 2024, which is incorporated herein by reference.

### TECHNICAL FIELD

The present disclosure relates to optical devices such as spotting scopes, cameras, binoculars, and other optical devices. More particularly, the present disclosure relates to an optical bracket for utilizing two optical devices of differing fields of view to achieve the same or similar focal point.

### BACKGROUND

Binoculars and spotting scopes have been used for a variety of activities, including birdwatching, skygazing, hunting, target shooting, tactical ranging, surveillance, and other purposes. In many scenarios, a user will use both binoculars and spotting scopes for the same activity. For example, a user may generally scan the desired field of view using binoculars to locate the item of interest (e.g., target). Once the desired viewpoint or target is identified, a user will then often change to a spotting scope having a higher magnification than binoculars. Due to their higher magnification, spotting scopes are often used with tripods to minimize image disturbance from movement and vibrations.

However, one of the difficulties when switching from binoculars to the spotting scope is locating the desired viewpoint or target once again. Despite attempting to line up the focal point of the binoculars with the tripod's focal point, it can be difficult to estimate the location. Additionally, the time required to locate the item of interest with the spotting scope may cause an unwanted delay, which can be detrimental. For example, if a user is bird watching, seconds can be critical as the bird can fly off when a user is trying to relocate the bird using the spotting scope. The same occurs with cameras or other optical devices. As a result, the birdwatcher may not be able to get the close-up view desired or a photo of the bird. The same may be true for hunting, military operations, and other scenarios where multiple optical devices are frequently used together.

Accordingly, there is a need for an apparatus that allows optical devices, such as binoculars and spotting scopes, cameras, etc. to have the same focal point, and that allows a user to effortlessly switch between the two. The present disclosure solves these problems and others.

### SUMMARY OF EXAMPLE EMBODIMENTS

In some embodiments, an optical bracket for combining optic devices comprises a lower arm couplable to a tripod, an upper arm couplable to the lower arm, and a top base hingedly coupled to the upper arm.

In some embodiments, the upper arm is vertically adjustable in relation to the lower arm, and the top base is angle adjustable in relation to the upper arm.

In some methods of use, a user couples the lower arm to a tripod, couples a spotting scope (or other optical device) to the tripod, the lower arm configured to extend around the side of the spotting scope, couples the upper arm to the lower arm, and couples binoculars (or other optical device) to the top base of the upper arm. A user may further adjust the vertical position of the upper arm in relation to the lower arm to ensure that the binoculars do not interfere with the use of the spotting scope. Further, to ensure that the focal point of the binoculars matches that of the spotting scope, the user may adjust the angle of the binoculars in relation to upper arm.

A user would first scan the field using the binoculars to identify the item of interest, and would then tilt the binoculars forward via the hinge of the top base and upper arm so that the spotting scope may easily be used without interference. Because the focal point of the binoculars and the spotting scope are the same, the user need not relocate the item of interest, saving precious time.

For ease of understanding, examples of binoculars and spotting scopes are used herein. However, it will be appreciated that the present disclosure is not so limited, and that other optical devices may be used in place of either the binoculars or the spotting scope without departing herefrom.

### BRIEF DESCRIPTION OF THE DRAWINGS

FIG. 1 illustrates a rear, left side perspective view of an optical bracket for combining optic devices in use in a first position;

FIG. 2 illustrates a right, side perspective view of an optical bracket for combining optic devices in use in a first position;

FIG. 3 illustrates a rear, right side perspective of an optical bracket for combining optic devices in use in a second position;

FIG. 4 illustrates a right, side perspective view of an optical bracket for combining optic devices;

FIG. 5 illustrates a left, side perspective view of an optical bracket for combining optic devices;

FIG. 6 illustrates a right, side perspective view of an optical bracket for combining optic devices in a storage position;

FIG. 7 illustrates a left perspective view of an optical bracket for combining optic devices in a storage position; and

FIG. 8 illustrates an exploded view of an optical bracket for combining optic devices.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As previously discussed, there is a need for an apparatus that allows optical devices, such as binoculars, spotting scopes, cameras, etc., to have the same focal point, and that allows a user to effortlessly switch between the two. The optical bracket for combining optic devices disclosed herein solves these problems and others.

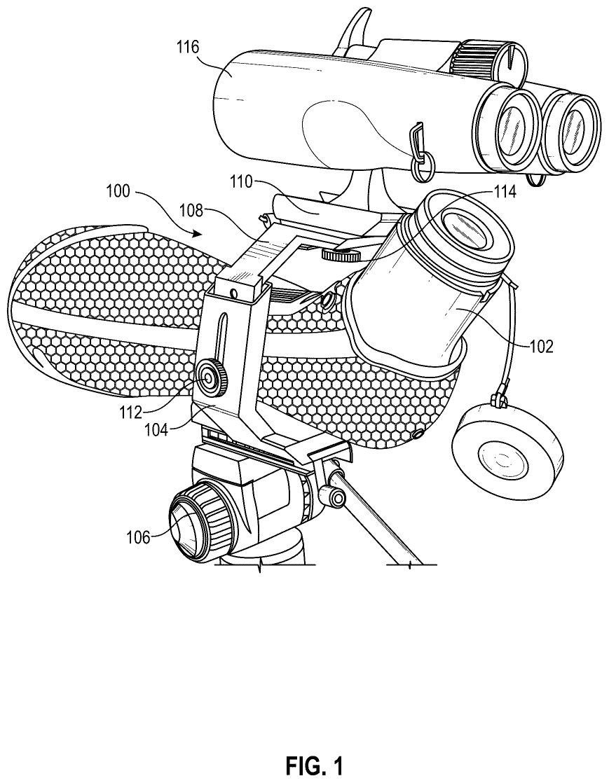

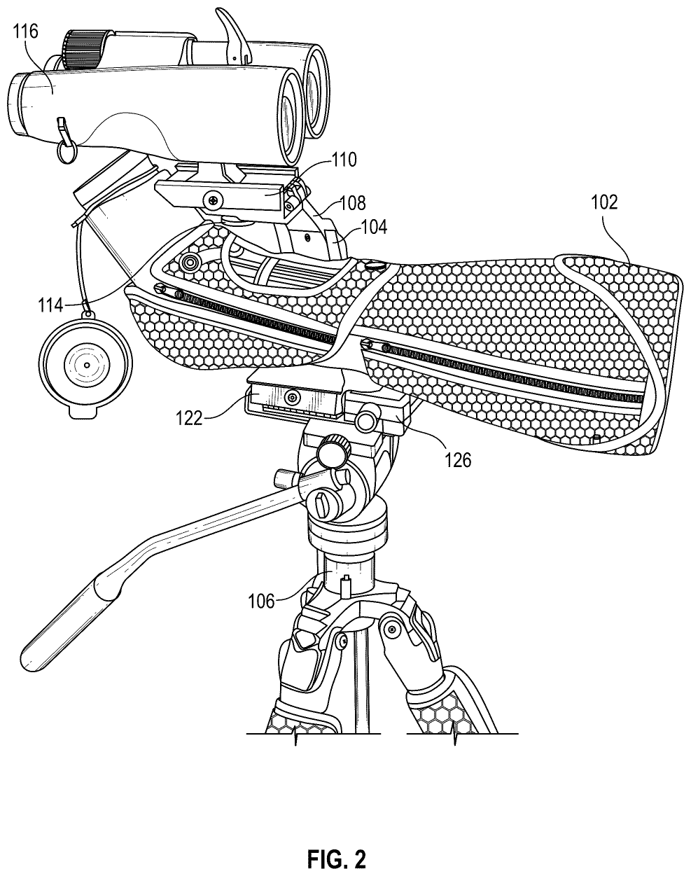

Referring to FIGS. 1-2, in some embodiments, an optical bracket 100 for use with a spotting scope 102 (or other optical device) comprises a lower arm 104 couplable to a tripod 106, an upper arm 108 couplable to the lower arm 104, and a top base 110 hingedly coupled to the upper arm 108. The upper arm 108 may be height adjustable in relation to the lower arm 104 via an adjustment knob 112 (e.g., set screw). For example, a user may loosen the adjustment knob 112, may then raise or lower the upper arm 108 to the desired position, and may then retighten the adjustment knob 112 to secure the upper arm 108 in relation to the lower arm 104.

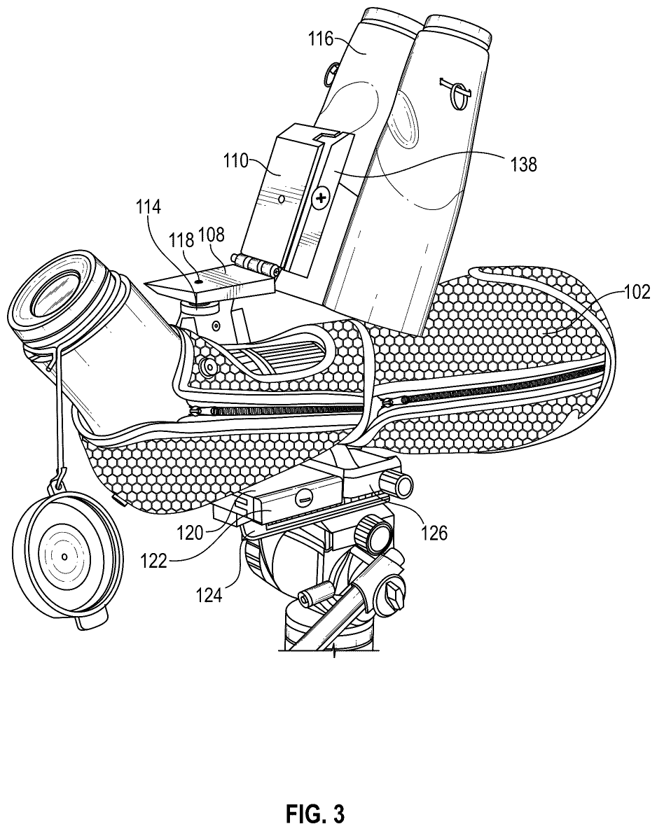

Further, an angle adjustment knob 114 may be configured to vertically adjust the focal point of the binoculars 116 by varying the angle of the top base 110 in relation to the upper arm 108. As best seen in FIG. 3, the adjustment knob 114 passes through the upper arm 108 such that as a user actuates the angle adjustment knob 114 in a first direction, the protrusion 118 (e.g., threaded bolt portion of knob 114) extends, thereby tilting the top base 110 forward, thereby lowering the focal point of the binoculars 116. When actuated in an opposite direction (e.g., threadably counterclockwise), the protrusion 118 withdraws and the angle between the top base 110 and the upper arm 108 is lowered, thereby raising the focal point of the binoculars 116. Accordingly, a user is able to make minute adjustments using the angle adjustment knob 114 to ensure the focal point of the binoculars 116 matches the focal point of the spotting scope 102.

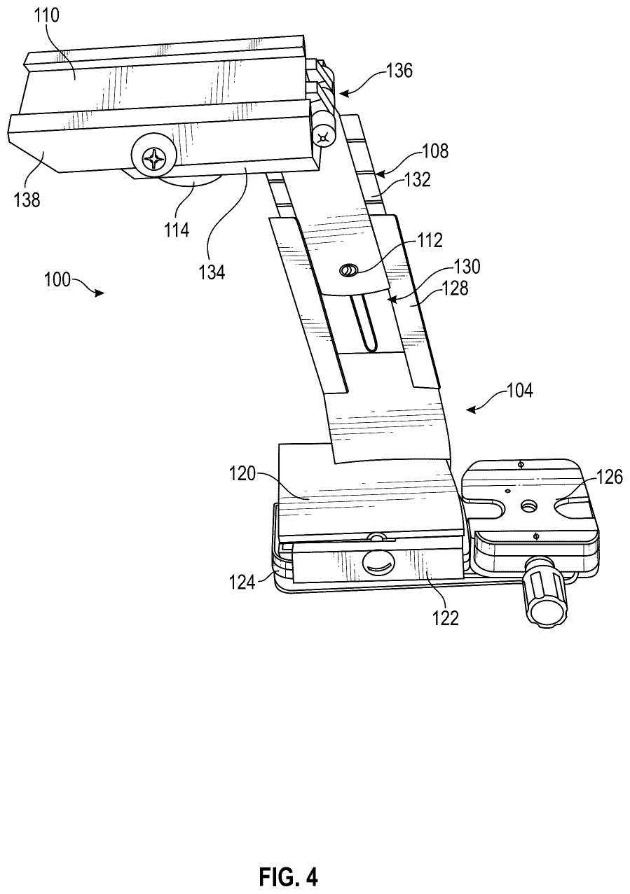

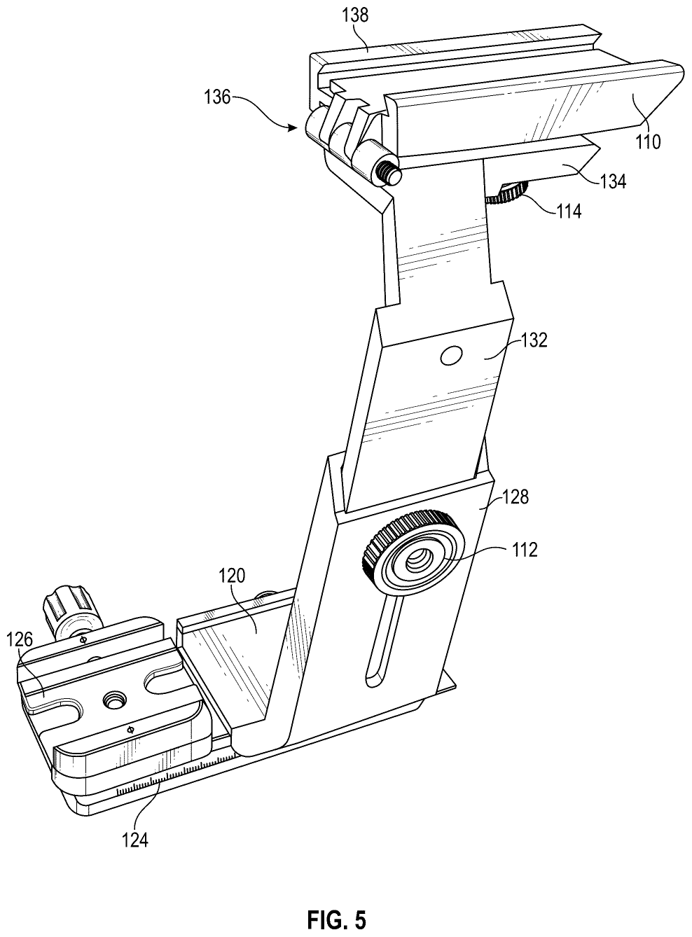

Referring to FIGS. 4-5, the lower arm 104 comprises a lower base 120 for coupling to a tripod. The lower base 120 may comprise a clamp 122 for positioning and securing the lower base 120 to a top plate 124 of a tripod head. As shown, the lower base 120 is sized so as to allow a spotting scope mount 126 to likewise couple to the top plate 124 of the tripod head. The lower arm 104 further comprises a vertical receiving arm 128 having one or more channels 130 to receive a vertical arm 132 of the upper arm 108. The vertical arm 132 may be secured in the desired position in relation to the channel 130 via the adjustment knob 112. In other words, the vertical arm 132 is slidable within the channel 130. Once the desired height is reached, the user tightens the adjustment knob 112, preventing further sliding of the vertical arm 132 in relation to the channel 130.

The upper arm 108 has a horizontal plate 134 that extends over the lower base 120. The top base 110 is coupled to the horizontal plate 134 via a hinge 136. A clamp 138 secures the binoculars to the top base 110.

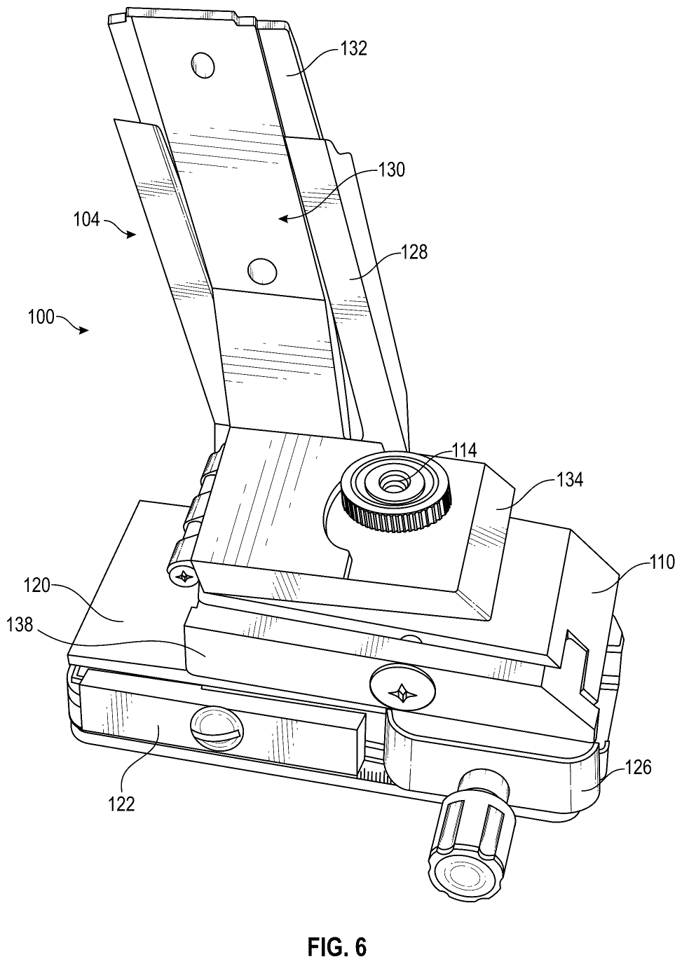

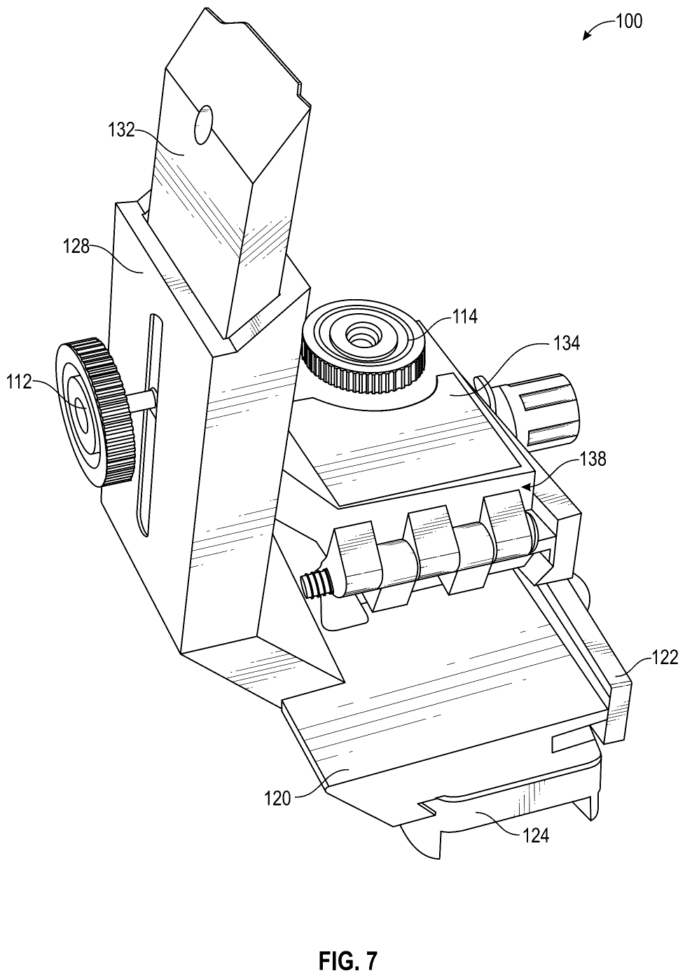

Referring to FIGS. 6-7, the optical bracket 100 may be configured into a storage position. As shown, the vertical arm 132 is inverted and then inserted into the channel 130 of the vertical receiving arm 128 of the lower arm 104. In this position, the top base 110 approximates or abuts the lower base 120 of the lower arm 104 and the spotting scope mount 126. It will be appreciated that in this position, the optical bracket 100 may be more easily stored and transported when not in use.

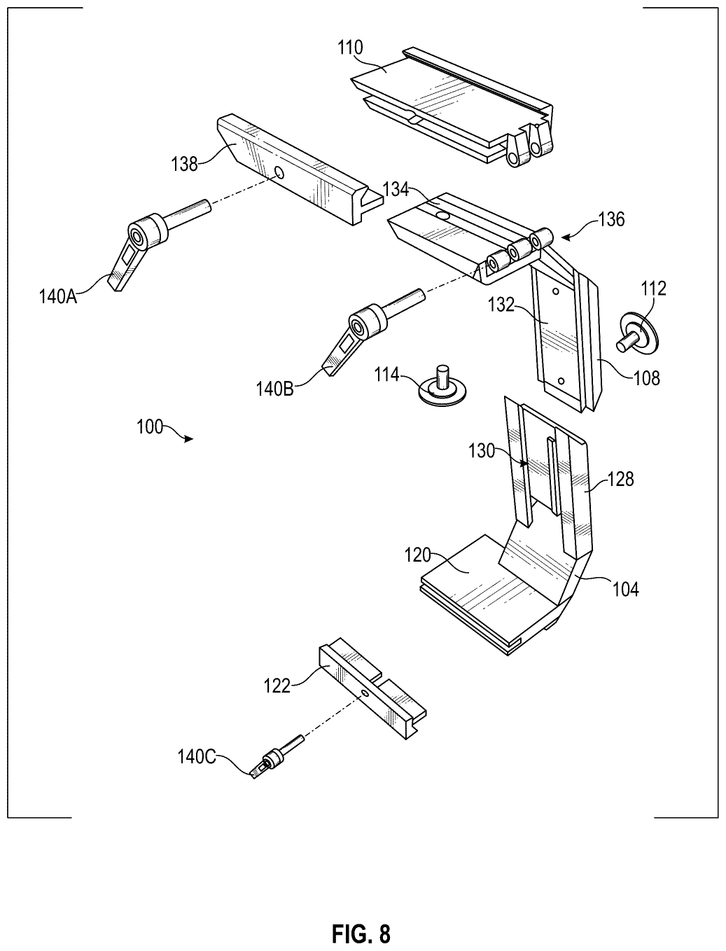

Referring to FIG. 8, it will be appreciated that one or more securing knobs 140A-C(e.g., cam lock, set screw, etc.) may be used to secure various components of the optical bracket 100. For example, securing knob 140A may secure the top clamp 138 to the top base 110, securing knob 140B may be used to secure the hinge 136, and securing knob 140C may be used to secure the bottom clamp 122 to the lower base 120.

In some methods of use, a user couples the lower arm 104 to a top plate 124 of a tripod 106 and couples a spotting scope mount 126 to the top plate 124 as well. As best seen in FIG. 1, the lower arm 104 is configured to extend around the side of the spotting scope 102. A user couples the upper arm 108 to the lower arm 104 by inserting the vertical arm 132 into the channel 130 of the vertical receiving arm 128. A user may further adjust the vertical position of the upper arm 108 in relation to the lower arm 104 to ensure that the binoculars do not interfere with the use of the spotting scope 102 using the adjustment knob 112. Further, to ensure that the focal point of the binoculars 116 matches that of the spotting scope 102, the user may adjust the angle of the binoculars 116 in relation to upper arm 108 via angle adjustment knob 114 and/or hinge 136.

Accordingly, in a first position, as shown in FIGS. 1-2, a user would first scan the field using the binoculars 116 to identify the item of interest, and would then pivot the binoculars 116 forward to a second position, as shown in FIG. 3, via the hinge 136 of the top base 110 and upper arm 108 so that the spotting scope 102 may easily be used without interference of the binoculars 116. Because the focal point of the binoculars 116 and the spotting scope 102 are the same (or proximate), the user need not relocate the item of interest when looking through the spotting scope 102, saving precious time. While a spotting scope 102 and binoculars have been used as examples herein, it will be appreciated that other devices may likewise be combined, such as a camera, scope, or other optical device, without departing herefrom. Additionally, while a tripod was also used as an example, it will be appreciated that other instruments may be used, such as supporting shafts, bipods, and others.

Accordingly, the optical bracket 100 disclosed herein solves the need for an apparatus that allows optical devices with differing fields of view to have the same relative focal point, and that allows a user to effortlessly switch between the two without losing the item of interest.

It will be appreciated that systems and methods according to certain embodiments of the present disclosure may include, incorporate, or otherwise comprise properties or features (e.g., components, members, elements, parts, and/or portions) described in other embodiments.

Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. An optical bracket, comprising:
a lower arm configured to be coupled to a top plate of a tripod, the lower arm comprising a vertical receiving arm;
an upper arm comprising a vertical arm and a horizontal plate, the upper arm configured to be coupled to the vertical receiving arm of the lower arm;
a top base hingedly coupled to the horizontal plate of the upper arm, the top base comprising a clamp configured to secure to an optical device.

2. The optical bracket of claim 1, further comprising an adjustment knob configured to secure the vertical arm in relation to the vertical receiving arm.

3. The optical bracket of claim 1, further comprising an angle adjustment knob configured to adjust the angle of the top base in relation to the horizontal plate.

4. The optical bracket of claim 1, wherein the vertical arm is coupled to the vertical receiving arm via a channel in the vertical receiving arm, the vertical arm configured to be slidable within the channel.

5. The optical bracket of claim 1, wherein the lower arm comprises a lower base having a clamp, the lower base and clamp configured to couple the lower arm to the top plate.

6. The optical bracket of claim 5, further comprising a first securing knob configured to actuate the clamp of the top base, and a second securing knob configured to actuate the clamp of the top plate.

7. An optical bracket, comprising:
a lower arm configured to be coupled to a top plate of a tripod, the lower arm comprising a lower base having a clamp and a vertical receiving arm extending upwardly from the lower base, the vertical receiving arm comprising a channel;
an upper arm comprising a vertical arm and a horizontal plate, the upper arm configured to be slidable in the channel of the vertical receiving arm of the lower arm, and an adjustment knob configured to secure the vertical arm in relation to the vertical receiving arm;
a top base hingedly coupled to the horizontal plate of the upper arm, the top base comprising a clamp configured to secure to an optical device, the top base configured to pivot forwardly on a hinge in relation to the horizontal plate of the upper arm.

8. The optical bracket of claim 7, further comprising an angle adjustment knob configured to adjust the angle of the top base in relation to the horizontal plate.

9. The optical bracket of claim 8, wherein the angle adjustment knob is configured to threadably insert from a bottom side of the horizontal plate and extend through the horizontal plate to form a protrusion on a top side of the horizontal plate, the protrusion configured to tilt the top base forwardly.

10. The optical bracket of claim 7, further comprising a first securing knob configured to actuate the clamp of the top base, and a second securing knob configured to actuate the clamp of the top plate.

11. A method of using an optical bracket, comprising:
securing a first optical device to a top plate of a tripod;
securing the optical bracket to the top plate of the tripod via a lower arm, the lower arm configured to extend around the first optical device;
coupling an upper arm to the lower arm, the upper comprising a horizontal plate and a top base hingedly coupled to the horizontal plate;
coupling a second optical device to the top plate; and
selectively tilting the second device, via a hinge, to a desired position.

12. The method of claim 11, further comprising securing the upper arm in relation to the lower arm via an adjustment knob.

13. The method of claim 11, further comprising adjusting a focal point of the second optical device by selectively actuating an angle adjustment knob.

14. The method of claim 11, wherein the first optical device is a spotting scope or camera and the second optical device is a pair of binoculars.
